(19) United States
(12) Patent Application Publication
(10) Pub. No.: US 2015/0197981 A1
(43) Pub. Date: Jul. 16, 2015

(54) ROMAN CURTAIN AND STRUCTURE FOR INSTALLATION OF THE ROMAN CURTAIN

(71) Applicant: Tsung-Ming Lai, New Taipei City (TW)

(72) Inventor: Tsung-Ming Lai, New Taipei City (TW)

(21) Appl. No.: 14/154,193

(22) Filed: Jan. 14, 2014

(51) Int. Cl. E06B 9/262; A47H 23/14; A47H 23/01; A47H 5/14

(52) U.S. Cl. CPC E06B 9/262; A47H 5/14; A47H 23/14; A47H 23/01; E06B 2009/2622; E06B 2009/785

(57) ABSTRACT

A Roman curtain comprises a retaining rod having a trench at an upper side thereof; two through holes passing through the trench to a bottom side thereof and a positioning unit; a curtain cloth with an upper edge thereof being fixed to the retaining rod; a weight; a plurality of suspending rings being arranged as two longitudinal banks; each suspending ring including a suspending ring body; a linking rod; and a transversal rod; the transversal rod and the suspending ring body being arranged at two opposite sides of the curtain cloth; a pulling rope set passing through the positioning unit and then dividing into two ropes which pass the two through holes and then to the lower side of the retaining rod and then the two pull ropes downwards extending to the lower side of the curtain cloth to be fixed to the weight.

### FIELD OF THE INVENTION

The present invention related to Roman curtains, and in particular to a Roman curtain and a structure for installation of the Roman curtain.

### BACKGROUND OF THE INVENTION

A prior art Roman curtain has a retaining rod; a curtain cloth with an upper edge thereof being fixed to the retaining rod; and a weight at a lower side of the weight. A plurality of suspending rings are installed to the curtain cloth. The plurality of suspending rings are arranged as two longitudinal banks at two sides of the curtain cloth. A pulling rope set has one free end. The pulling rope set passes through a positioning unit and then divides into two ropes which pass the two through holes from an upper side of the retaining rod and then to the lower side of the retaining rod and then the two pull ropes downwards extend to the lower side of the curtain cloth to be fixed to the weight. By pulling the free end of the pulling rope set, the curtain cloth can be pulled upwards or downwards. Furthermore, by using a positioning unit, the pulling rope set can be fixed at a desired position.

In the prior art, rope is seamed to the curtain cloth in several positions. The seaming operation is tedious and inconvenient. Furthermore, a distance between two suspending rings are too large to make a children head could pass through the space between two adjacent suspending rings. As a result, it is possible that the children head is clamped between suspending rings to cause breath to stop. Furthermore, in the prior art structure, it is difficult to replace the rope due to the installation way of the suspending rings.

### SUMMARY OF THE INVENTION

Accordingly, the object of the present invention is to provide a Roman curtain, wherein the suspending ring installing gun of the present invention, the suspending ring can be installed to the curtain cloth quickly so that the installation work for the whole curtain is easy and convenient and thus the whole cost in installation is down. No seaming work is needed the curtain cloth is undesired to detach. Furthermore, the distance between two adjacent suspending rings is less than a head size of a children and thus the children head will not be clamped between two suspending rings to cause the breath to stop. Therefore, the structure of the present invention matches the requirement of safety installation.

To achieve above object, the present invention provides a Roman curtain comprising: a retaining rod having a trench at an upper side thereof; two through holes passing through the trench to a bottom side thereof and a positioning unit installed between one of the through holes and a distal end of the trench; a curtain cloth with an upper edge thereof being fixed to the retaining rod; a weight at a lower side of the curtain cloth; a plurality of suspending rings combined to the curtain cloth; the plurality of suspending rings being arranged as two longitudinal banks at two sides of the curtain cloth; each suspending ring including a suspending ring body; a linking rod having one end extending from an outer side of the suspending ring body; and a transversal rod; another end of the linking rod being connected to a middle section of the transversal rod; the transversal rod and the suspending ring body being arranged at two opposite sides of the curtain cloth; and a pulling rope set having one free end; the pulling rope set passing through the positioning unit and then dividing into two ropes which pass the two through holes from an upper side of the retaining rod and then to the lower side of the retaining rod and then the two pull ropes downwards extending to the lower side of the curtain cloth to be fixed to the weight; by pulling the free end of the pulling rope set, the curtain cloth can be pulled upwards or downwards; furthermore, by using the positioning unit, the pulling rope set can be fixed at a desired position.

Furthermore, the present invention provides a structure for installing curtain suspending rings to a curtain, comprising: a suspending ring set comprising a linking bar having a plurality of guide rods vertically extended from the bar body of the linking bar; each guide bar being connected to a middle section of a transversal rod; a linking rod having one end extending from a middle section of the transversal rod at a side opposite to the side connected to the guide bar; another end of the linking rod being connected to an outer lateral side of a suspending ring body; the suspending ring body, the linking rod and the transversal rod being formed as a suspending ring; a diameter of the guide bar being smaller than that of the transversal rod so that the guide bar can be broken out from the transversal rod easily; moreover, a suspending ring installing gun comprising: a gun body having a installing head having a penetrating slot; an actuating unit having a push rod and a press unit serving for driving the push rod to move axially; a suspending ring driving unit being driven by the actuating unit to pull the suspending ring set downwards to a standby position so that a lowest one of the suspending rings in the suspending ring set being positioned in the penetrating slot of the installing head; and wherein in using the installing head with a tip head passes through a curtain cloth to cause an opening of the penetrating slot of the installing head is at a backside of the curtain cloth; the push rod of the suspending ring installing gun will break the suspending ring from the linking bar; then the transversal rod will be driven to the backside of the curtain cloth; the press unit will break the guide bar to leave from the transversal rod and causes the transversal rod to move along the penetrating slot to the backside of the curtain cloth; and then the suspending ring driving unit will be driven by the actuating unit to cause the suspending ring set to move downwards to the standby position; then the installing head of the suspending ring installing gun is drawn out; then driving the suspending ring installing gun to leave from the curtain cloth so as to draw the installing head from the curtain cloth; and thus, one suspending ring is installed to the curtain cloth.

### BRIEF DESCRIPTION OF THE DRAWINGS

FIG. 1 is a perspective view of the present invention.

FIG. 2 is a front side view of the suspending ring of the present invention.

FIG. 3 is a rear side view of the suspending ring of the present invention.

FIG. 4 is an enlarged schematic view showing the folding of the curtain cloth of the present invention.

FIG. 5 shows another embodiment of the suspending ring of the present invention.

FIG. 6 shows another embodiment of the present invention.

FIG. 7 shows a flow diagram about the operation of the present invention.

FIG. 8 is a perspective enlarged view about the suspending ring set of the present invention.

FIG. 9 is a structural view about the suspending ring installing gun of the present invention.

FIG. 10 is a schematic view showing the operation of installing a suspending ring to a curtain cloth according to the present invention

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

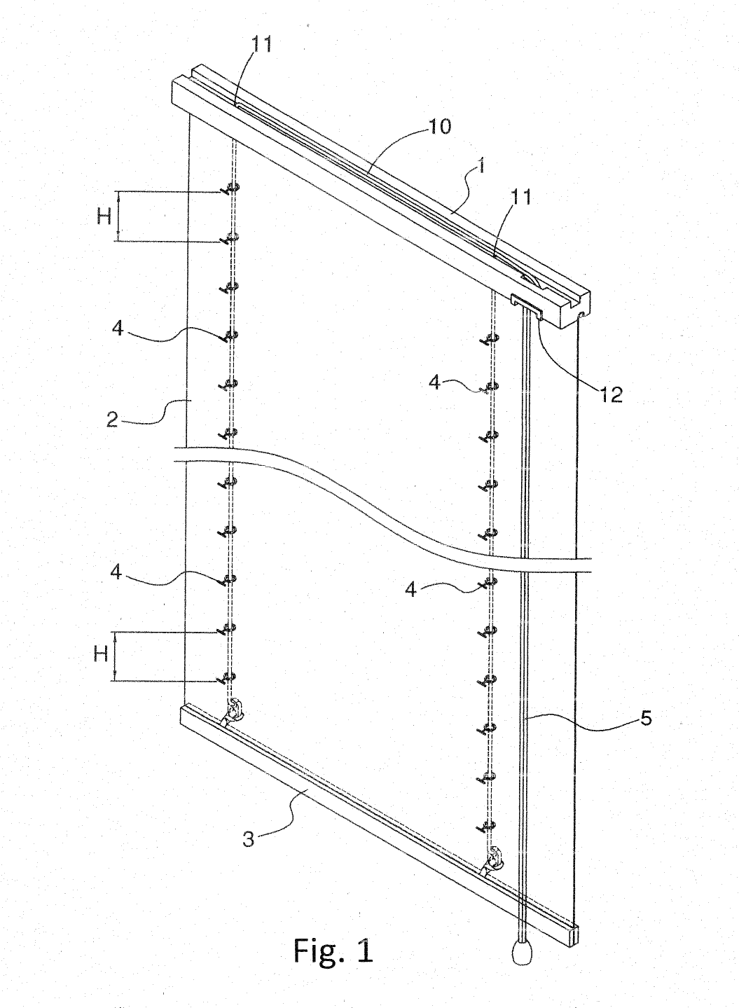

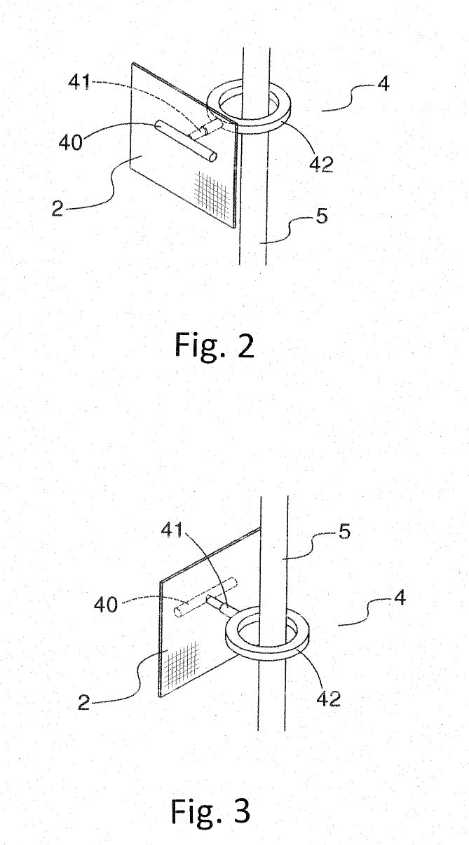

With reference to FIGS. 1 to 4, the structure of Roman curtain (i.e., Roman blinds) of the present invention is illustrated. The present invention has the following elements.

A retaining rod 1 has a trench 10 at an upper side thereof; two through holes 11 passing through the trench 10 to a bottom side thereof and a positioning unit 12 installed between one of the through holes 11 and a distal end of the trench 10.

A curtain cloth 2 with an upper edge thereof is fixed to the retaining rod 1.

A weight 3 is at a lower side of the curtain cloth 2.

A plurality of suspending rings 4 combined to the curtain cloth 2. The plurality of suspending rings 4 are arranged as two longitudinal banks at two sides of the curtain cloth 2. For each bank, a distance between two adjacent suspending rings is not greater than 10 to 15 cm. Each suspending ring 4 is formed by plastic material and is integral formed. Each suspending ring 4 includes a suspending ring body 42; a linking rod 41 having one end extending from an outer side of the suspending ring body 42; and a transversal rod 40. Another end of the linking rod 41 is connected to a middle section of the transversal rod 40. The transversal rod 40 and the suspending ring body 42 are arranged at two opposite sides of the curtain cloth 2.

A pulling rope set 5 has one free end. The pulling rope set 5 passes through the positioning unit 12 and then divides into two ropes which pass the two through holes 11 from an upper side of the retaining rod 1 and then to the lower side of the retaining rod 1 and then the two pull ropes 5 downwards extend to the lower side of the curtain cloth 2 to be fixed to the weight 3. By pulling the free end of the pulling rope set 5, the curtain cloth 2 can be pulled upwards or downwards. Furthermore, by using the positioning unit 12, the pulling rope set 5 can be fixed at a desired position.

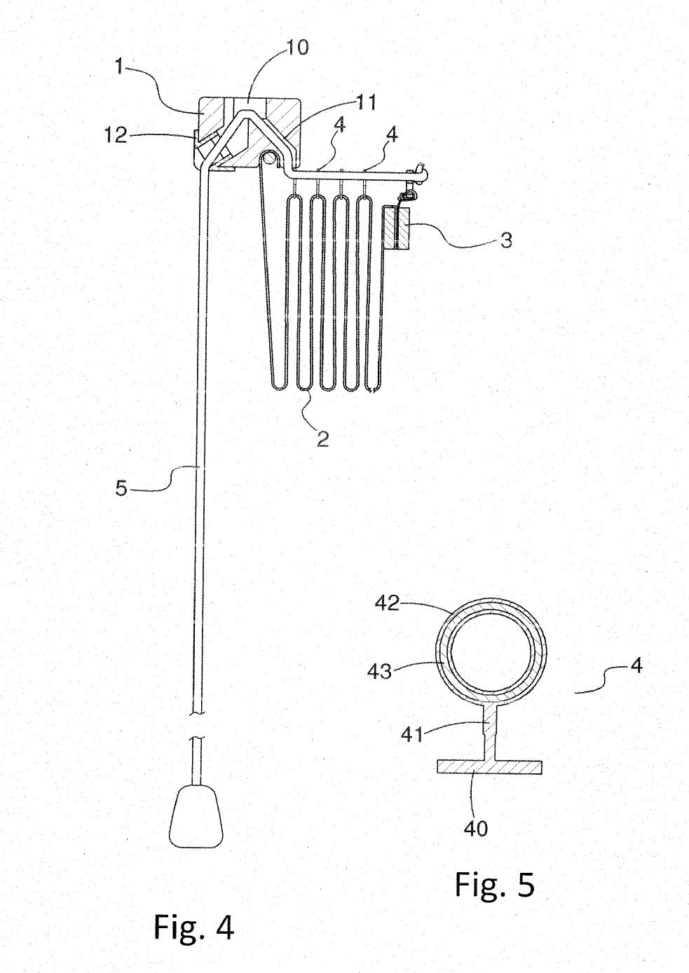

In operation, when the user pulls the pulling rope set 5 upwards, the weight 3 will move upwards until it is resisted by a lowest suspending ring 4. At this moment, the curtain cloth 2 below the lowest suspending ring will be folded to form as a fold. If the pulling rope set 5 is pulled upwards continuously, the curtain cloth 2 will touch the second suspending ring 4 so as to form as a second fold. The operation is performed continuously until all the curtain cloth 2 is folded as illustrated in FIG. 4.

With reference to FIG. 5, it is illustrated that the suspending ring body 42 of the suspending ring 4 is enclosed by a metal enclosure 43.

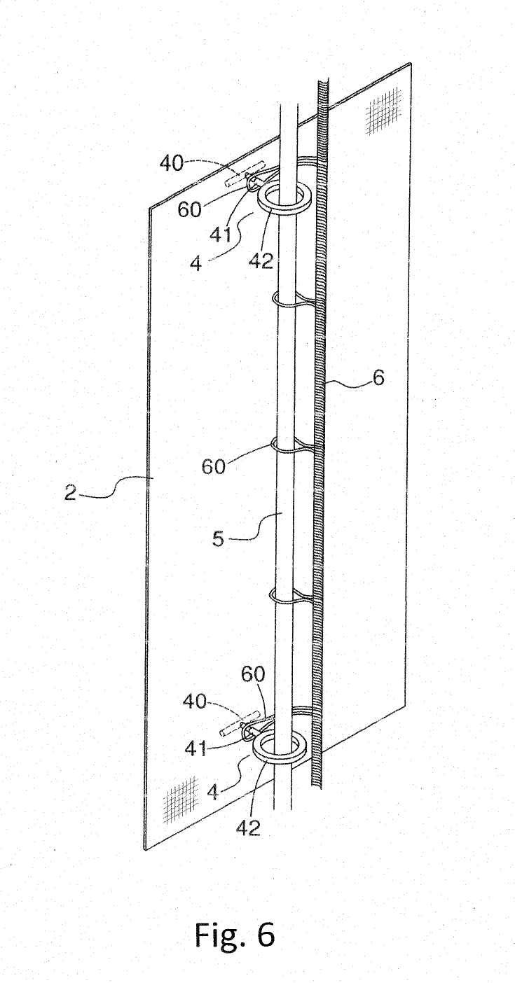

With reference to FIG. 6, another embodiment of the present invention is illustrated. In this embodiment, all the elements are like those illustrated in the embodiment shown in FIGS. 1 to 5, while in this embodiment, two safety ropes 6 are further added to the curtain structure of the present invention.

Two ends of each safety rope 6 are fixed to the retaining rod 1 and the weight 3. A plurality of safe rings 60 are formed along each safety rope 6. A distance between two adjacent safe rings 60 is smaller than that of the two adjacent suspending rings 4. Some of the safe rings 60 are passed through by the linking rods 41 of the suspending rings 4 and some of the safe rings 60 are passed through by the pulling ropes of the pulling rope set 5.

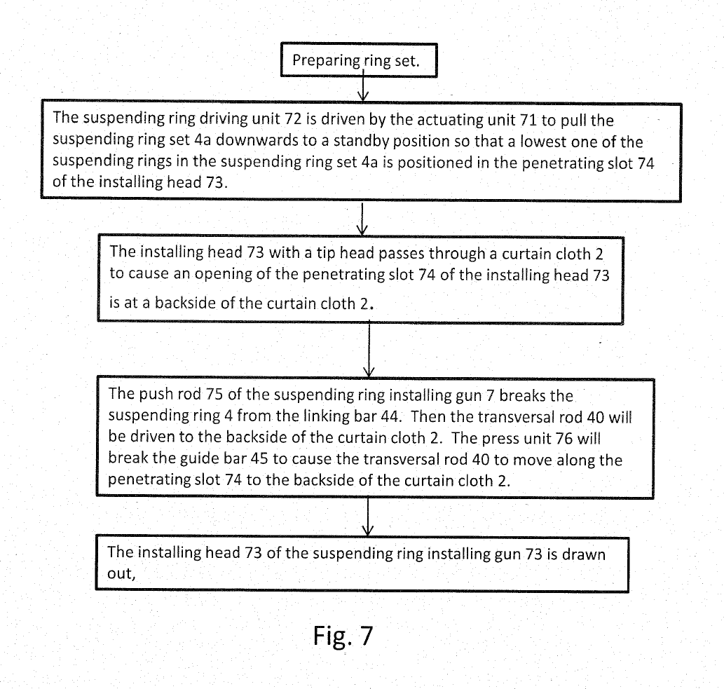

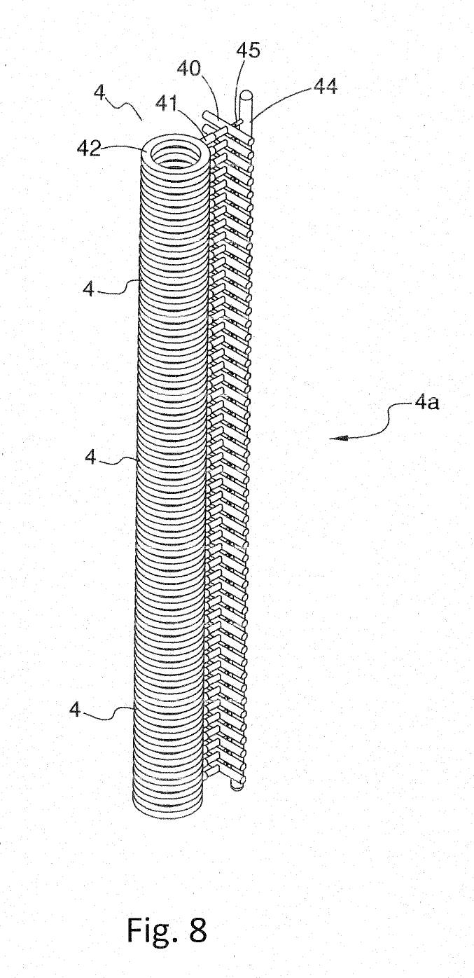

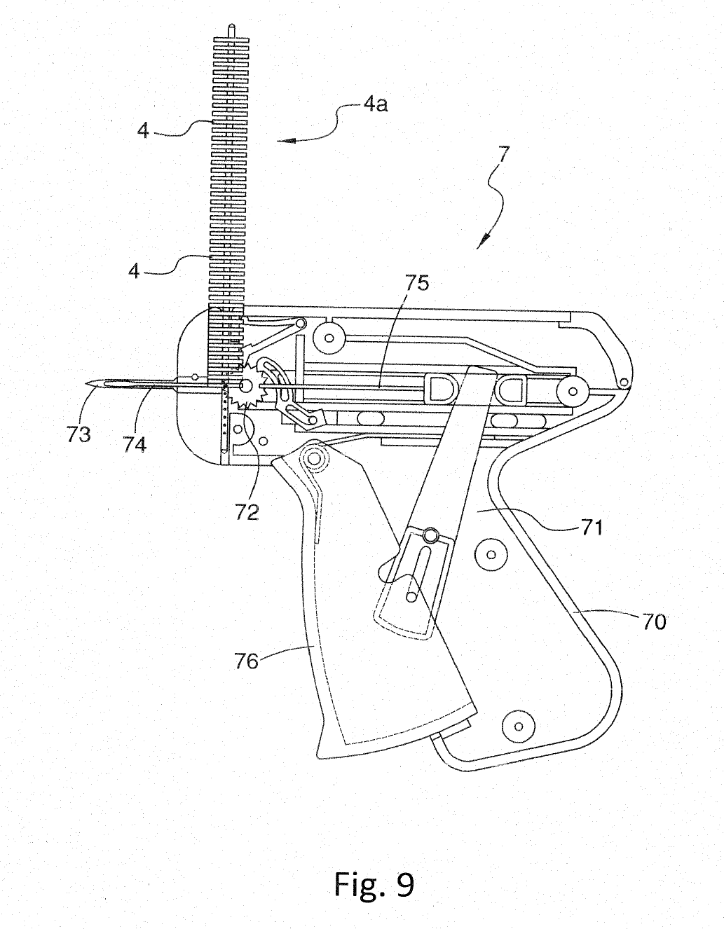

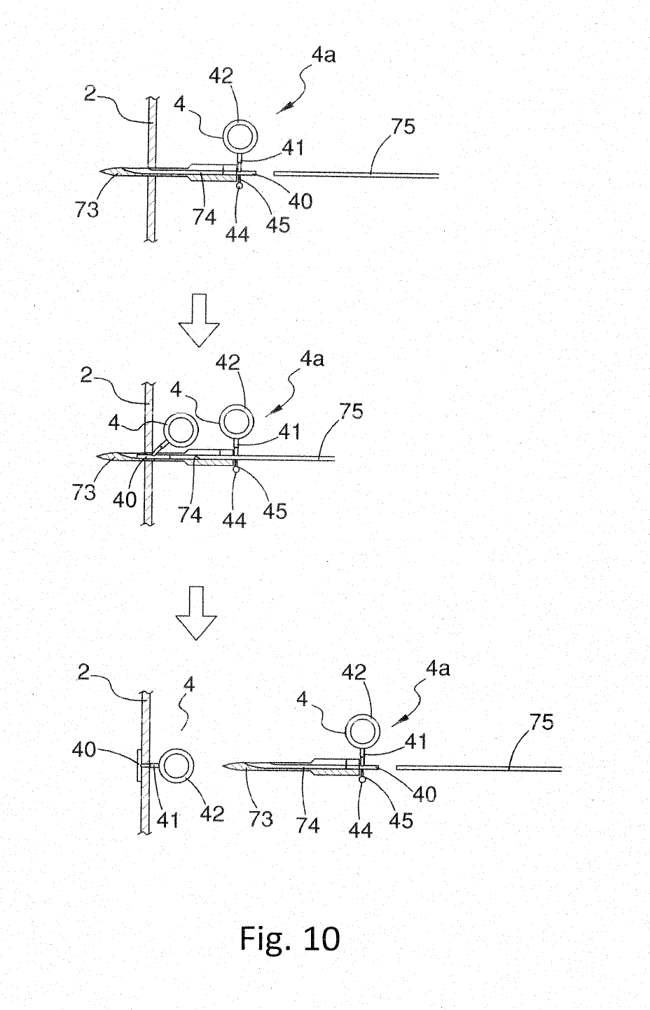

With reference to FIGS. 7 to 10, the assembly way for the present invention is illustrated.

A suspending ring set 4a comprises the following elements:

A linking bar 44 has a plurality of guide rods 45 vertically extended from the bar body of the linking bar 44. Each guide bar 45 is connected to a middle section of a transversal rod 40. A linking rod 41 has one end extending from a middle section of the transversal rod 40 at a side opposite to the side connected to the guide bar 45. Another end of the linking rod 41 is connected to an outer lateral side of a suspending ring body 42. The suspending ring body 43, the linking rod 41 and the transversal rod 40 are formed as a suspending ring 4. A diameter of the guide bar 45 is smaller than that of the transversal rod 40 so that the guide bar 45 can be broken out from the transversal rod 40 easily.

A suspending ring installing gun 7 comprises the following elements

A gun body 70 has a installing head 73 having a penetrating slot 74. An actuating unit 71 has a push rod 75 and a press unit 76 serving for driving the push rod 75 to move axially. A suspending ring driving unit 72 is driven by the actuating unit 71 to pull the suspending ring set 4a downwards to a standby position so that a lowest one of the suspending rings in the suspending ring set 4a is positioned in the penetrating slot 74 of the installing head 73.

In using the installing head 73 with a tip head passes through a curtain cloth 2 to cause an opening of the penetrating slot 74 of the installing head 73 is at a backside of the curtain cloth 2.

The push rod 75 of the suspending ring installing gun 7 will break the suspending ring 4 from the linking bar 44. Then the transversal rod 40 will be driven to the backside of the curtain cloth 2. The press unit 76 will break the guide bar 45 to leave from the transversal rod 40 and causes the transversal rod 40 to move along the penetrating slot 74 to the backside of the curtain cloth 2. Then the suspending ring driving unit 72 will be driven by the actuating unit 71 to cause the suspending ring set 4 to move downwards to the standby position.

Then the installing head 73 of the suspending ring installing gun 73 is drawn out, driving the suspending ring installing gun 7 to leave from the curtain cloth 2 so as to draw the installing head 73 from the curtain cloth 2. Thus, one suspending ring 4 is installed to the curtain cloth 2.

However, by the suspending ring installing gun of the present invention, the suspending ring can be installed to the curtain cloth quickly so that the installation work for the whole curtain is easy and convenient and thus the whole cost in installation is down. No seaming work is needed the curtain cloth is undesired to detach. Furthermore, the distance between two adjacent suspending rings is less than a head size of a child and thus the children head will not be clamped between two suspending rings to cause the breath to stop. Therefore, the structure of the present invention matches the requirement of safety installation.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A Roman curtain comprising:
a retaining rod having a trench at an upper side thereof; two through holes passing through the trench to a bottom side thereof and a positioning unit installed between one of the through holes and a distal end of the trench;
a curtain cloth with an upper edge thereof being fixed to the retaining rod;
a weight at a lower side of the curtain cloth;
a plurality of suspending rings combined to the curtain cloth; the plurality of suspending rings being arranged as two longitudinal banks at two sides of the curtain cloth; each suspending ring including a suspending ring body; a linking rod having one end extending from an outer side of the suspending ring body; and a transversal rod; another end of the linking rod being connected to a middle section of the transversal rod; the transversal rod and the suspending ring body being arranged at two opposite sides of the curtain cloth;
a pulling rope set having one free end; the pulling rope set passing through the positioning unit and then dividing into two ropes which pass the two through holes from an upper side of the retaining rod and then to the lower side of the retaining rod and then the two pull ropes downwards extending to the lower side of the curtain cloth to be fixed to the weight; by pulling the free end of the pulling rope set, the curtain cloth can be pulled upwards or downwards; furthermore, by using the positioning unit, the pulling rope set can be fixed at a desired position.

2. The Roman curtain as claimed in claim 1, further comprising: two safety ropes; two ends of each safety rope being fixed to the retaining rod and the weight; a plurality of safe rings being formed along each safety rope; some of the safe rings being passed through by the linking rods of the suspending rings and some of the safe rings being passed through by the pulling ropes of the pulling rope set.

3. The Roman curtain as claimed in claim 1, wherein a distance between two adjacent safe rings is smaller than that of the two adjacent suspending rings.

4. The Roman curtain as claimed in claim 1, wherein for each bank, a distance between two adjacent suspending rings is not greater than 10 to 15 cm.

5. The Roman curtain as claimed in claim 1, wherein each suspending ring is formed by plastic material and is integral formed.

6. The Roman curtain as claimed in claim 1, wherein the suspending ring body of the suspending ring is enclosed by a metal enclosure.

7. A structure for installing curtain suspending rings to a curtain, comprising:
a suspending ring set comprising a linking bar having a plurality of guide rods vertically extended from the bar body of the linking bar; each guide bar being connected to a middle section of a transversal rod; a linking rod having one end extending from a middle section of the transversal rod at a side opposite to the side connected to the guide bar; another end of the linking rod being connected to an outer lateral side of a suspending ring body; the suspending ring body, the linking rod and the transversal rod being formed as a suspending ring; a diameter of the guide bar being smaller than that of the transversal rod so that the guide bar can be broken out from the transversal rod easily;
a suspending ring installing gun comprising: a gun body having a installing head having a penetrating slot; an actuating unit having a push rod and a press unit serving for driving the push rod to move axially; a suspending ring driving unit being driven by the actuating unit to pull the suspending ring set downwards to a standby position so that a lowest one of the suspending rings in the suspending ring set being positioned in the penetrating slot of the installing head; and
wherein in using the installing head with a tip head passes through a curtain cloth to cause an opening of the penetrating slot of the installing head is at a backside of the curtain cloth; the push rod of the suspending ring installing gun will break the suspending ring from the linking bar; then the transversal rod will be driven to the backside of the curtain cloth; the press unit will break the guide bar to leave from the transversal rod and causes the transversal rod to move along the penetrating slot to the backside of the curtain cloth; and then the suspending ring driving unit will be driven by the actuating unit to cause the suspending ring set to move downwards to the standby position; then the installing head of the suspending ring installing gun being drawn out; then driving the suspending ring installing gun to leave from the curtain cloth so as to draw the installing head from the curtain cloth; and thus, one suspending ring is installed to the curtain cloth.
